(19) United States
(12) Patent Application Publication
(10) Pub. No.: US 2021/0094373 A1
(43) Pub. Date: Apr. 1, 2021

(54) DOUBLE LANDING GEAR FOR TRAILER

(71) Applicant: IDEAL WAREHOUSE INNOVATIONS, INC., Vaughan (CA)

(72) Inventor: Joseph J. Di Biase, Vaughan (CA)

(21) Appl. No.: 17/034,123

(22) Filed: Sep. 28, 2020

Related U.S. Application Data
(60) Provisional application No. 62/907,994, filed on Sep. 30, 2019.

(51) Int. Cl. B60D 1/66; B60S 9/02

(52) U.S. Cl. CPC B60D 1/66; B60S 9/02

(57) ABSTRACT

A landing gear assembly for a trailer includes a first brace assembly having an outer surface, an inner surface, a top edge, a front sloped edge and a back sloped edge, the top edge having a first clamping assembly for engaging and retaining a bottom of the trailer; a second brace assembly having an outer surface, an inner surface, a top edge, a front sloped edge and a back sloped edge, the top edge having a second clamping assembly for engaging and retaining the bottom of the trailer, at least a pair of landing gears attached to the brace surfaces, and a rotating assembly for operating the first, second, third, and fourth landing gears in tandem.

### RELATED APPLICATIONS

This application claims the benefit of U.S. Provisional Application No. 62/907,994 filed Sep. 30, 2019, which is hereby incorporated herein by reference.

### FIELD

The present invention relates to supports for trailers. Specifically the present invention relates to landing gears for trailers.

### BACKGROUND

When a freight semi-trailer is set down on its landing gear, the semi-trailer is freestanding. Associated pneumatic and electrical connections between the truck and trailer are disconnected so that the brakes of the freight trailer are locked. The trailer is left adjacent to the dock opening, supported at the front end using only the trailer's landing gear.

The landing gear assemblies are typically made of metal such as steel which eventually corrodes. Corrosion leads to failure of the landing gear, which may result in tipping of the trailer. Tipping of the trailer can result in damage to any goods within the trailer, the trailer itself, and the forklift, as well as injury to, or death of, the operator.

Landing gears for freight trailers are not typically designed to accommodate the weight of a fully loaded trailer, let alone the dynamic forces generated by a forklift moving through a partially loaded trailer. The high center of gravity associated with most trailers makes the likelihood of tipping over a real possibility.

Tipping may also occur when the pavement or ground under a trailer is uneven or has asphalt hollows or other unforeseen irregularities.

Current landing gear assemblies are often welded onto a freight trailer. Welds are difficult to inspect and are known to crack when stressed.

A common way to stabilize trailers is to use a trailer stand. Most trailer stands use a pneumatic jack that is operable and positionable through the hydraulic system of a shunt truck. This type of device requires the operator to hook up, make positioning adjustments, and disconnect the device, while on the bed of the shunt truck. This leaves the operator in a vulnerable position between the cab of the shunt truck and the semi-trailer.

The discussion of the background herein is included solely to explain the context of the invention described herein. This is not to be taken as an admission that any of the material referred to was published, known, or part of the common general knowledge as of the priority date of any of the claims.

### SUMMARY

There is a need for a trailer landing gear assembly that prevents tipping when a landing gear fails. There is a need for a landing gear assembly that does not require welding to assemble. There is a further need for a landing gear assembly that replaces the need for a manually placed trailer stand and does not require an operator to position or adjust. There is a further need for a landing gear assembly that is retrofittable to existing trailers.

In accordance with an aspect, there is provided a landing gear for a trailer, the landing gear comprising a first brace assembly having an outer surface, an inner surface, a top edge, a front sloped edge and a back sloped edge, the top edge having a first clamping assembly for engaging and retaining a bottom of the trailer, a second brace assembly having an outer surface, an inner surface, a top edge, a front sloped edge and a back sloped edge, the top edge having a second clamping assembly for engaging and retaining the bottom of the trailer, a first landing gear attached to the first brace outer surface, a second landing gear attached to the first brace inner surface, a third landing gear attached to the second brace outer surface, a fourth landing gear attached to the second brace inner surface, a center support assembly for connecting the first brace to the second brace, and a rotating assembly for operating the first, second, third, and fourth landing gears in tandem.

In accordance with another aspect, there is provided a landing gear assembly for a trailer, the landing gear assembly comprising a first brace assembly having an outer surface, an inner surface, a top edge, a front sloped edge and a back sloped edge, the top edge having a plurality of first clamping assemblies for engaging and retaining a bottom of the trailer, a second brace assembly having an outer surface, an inner surface, a top edge, a front sloped edge and a back sloped edge, the top edge having a second clamping assemblies for engaging and retaining the bottom of the trailer, a first landing gear attached to the first brace outer surface, a second landing gear attached to the second brace outer surface, a center support assembly for connecting the first brace to the second brace, and a rotating assembly for operating the first and second landing gears in tandem.

In accordance with another aspect, there is provided an auxiliary leg assembly for a trailer, the auxiliary leg assembly comprising a housing having a first compartment and a second compartment, an adjustable leg housed within the first compartment and releasably secured in the housing, a counterweight operably housed in the second compartment and connected to the adjustable leg for causing the gradually downward movement of the adjustable leg when the adjustable leg is released from the housing, and a securing mechanism for securing the adjustable leg in the first compartment after it descends to a desired height.

It is understood that one or more of the aspects described herein (and above) may be combined in any suitable manner. The novel and inventive features of the present invention will become apparent to those of skill in the art upon examination of the following detailed description of the invention. It should be understood, however, that the detailed description of the present invention and the specific examples presented, while indicating certain aspects of the invention, are provided for illustration purposes only because various changes and modifications within the spirit and scope of the invention will become apparent to those of skill in the art from the detailed description of the invention and claims that follow.

### BRIEF DESCRIPTION OF THE DRAWINGS

The present invention will be further understood from the following description with reference to the Figures, in which:

FIG. 1 shows a perspective view of an exemplary landing gear assembly for a trailer.

FIG. 2 shows a front view of the landing gear assembly of FIG. 1.

FIG. 3 shows a rear view of the landing gear assembly of FIG. 1.

FIG. 4 is a top view of the landing gear assembly of FIG. 1.

FIG. 5 is a bottom view of the landing gear assembly of FIG. 1.

FIG. 6 is an outer side view of the landing gear assembly of FIG. 1.

FIG. 7 is an inner side view of the landing gear assembly of FIG. 1.

FIG. 8 shows a perspective view of a V-brace assembly of the landing gear of FIG. 1.

FIG. 9 shows a front view of the V-brace assembly of FIG. 8.

FIG. 10 shows a side view of the V-brace assembly of FIG. 8.

FIG. 11 shows a top view of the V-brace assembly of FIG. 8.

FIG. 12 shows a bottom view of the V-brace assembly of FIG. 8.

FIG. 13 shows a perspective view of a gusset of the V-brace assembly of FIG. 8.

FIG. 14 shows a side view of the gusset of FIG. 13.

FIG. 15 shows a front view of the gusset of FIG. 13.

FIG. 16 shows a top view of the gusset of FIG. 13.

FIG. 17 shows a bottom view of the gusset of FIG. 13.

FIG. 18 shows perspective view of a tie plate of the V-brace assembly of FIG. 8.

FIG. 19 shows a perspective view of a support rod of the V-brace assembly of FIG. 8.

FIG. 20 shows perspective view of a landing gear with a gear box.

FIG. 21 shows a perspective view of a single speed landing gear.

FIG. 22 shows a perspective view of a U-strap of the landing gear assembly of FIG. 1.

FIG. 23 shows a perspective view of a U-strap and support plate of the landing gear assembly of FIG. 1.

FIG. 24 shows a perspective view of a center rotating bar of the landing gear assembly of FIG. 1.

FIG. 25 shows a perspective view of an adjustable center rotating bar of the landing gear assembly of FIG. 1.

FIG. 26 shows a perspective view of a rotating connecting cylinder of the landing gear assembly of FIG. 1.

FIG. 27 shows a perspective view of a center support brace of the landing gear assembly of FIG. 1.

FIG. 28 shows a perspective view of a cross brace of the landing gear assembly of FIG. 1.

FIG. 29 shows a perspective view of a clamping assembly of the landing gear assembly of FIG. 1.

FIG. 30 shows a perspective view of a top-clamp of the clamping assembly of FIG. 29.

FIG. 31 shows a perspective view of a clamp support plate for the top-clamp of FIG. 30.

FIG. 32 shows a side view of the landing gear assembly of FIG. 1 in operation.

FIG. 33 shows a close-up side perspective view of the clamping assemblies in operation.

FIG. 34 shows a cut-away top perspective view of the clamping assemblies in operation.

FIG. 35 shows a close-up side perspective view of an alternative embodiment of the clamping assemblies in operation.

FIG. 36 shows a close-up side perspective view of another embodiment of the clamping assemblies in operation.

FIG. 37 shows a perspective view of an exemplary auxiliary leg assembly.

FIG. 38 shows a front sectional view of the auxiliary leg assembly through section line A-A on FIG. 37.

FIG. 39 shows an exploded perspective view of the components of the auxiliary leg assembly of FIG. 37.

FIG. 40 shows a front view of the auxiliary leg assembly of FIG. 37.

FIG. 41 shows a rear view of the auxiliary leg assembly of FIG. 37.

FIG. 42 shows a side view of the auxiliary leg assembly of FIG. 37.

FIG. 43 shows a top view of the auxiliary leg assembly of FIG. 37.

FIG. 44 shows a bottom view of the auxiliary leg assembly of FIG. 37.

FIG. 45 shows a perspective view of the housing of the auxiliary leg assembly of FIG. 37.

FIG. 46 shows a perspective view of the adjustable leg of the auxiliary leg assembly of FIG. 37.

FIG. 47 shows a perspective view of the pulley of the auxiliary leg assembly of FIG. 37.

FIG. 48 shows a perspective view of the counter-weight of the auxiliary leg assembly of FIG. 37.

FIG. 49 shows a perspective view of the auxiliary leg assembly of FIG. 37 attached to a trailer.

### DETAILED DESCRIPTION OF CERTAIN ASPECTS

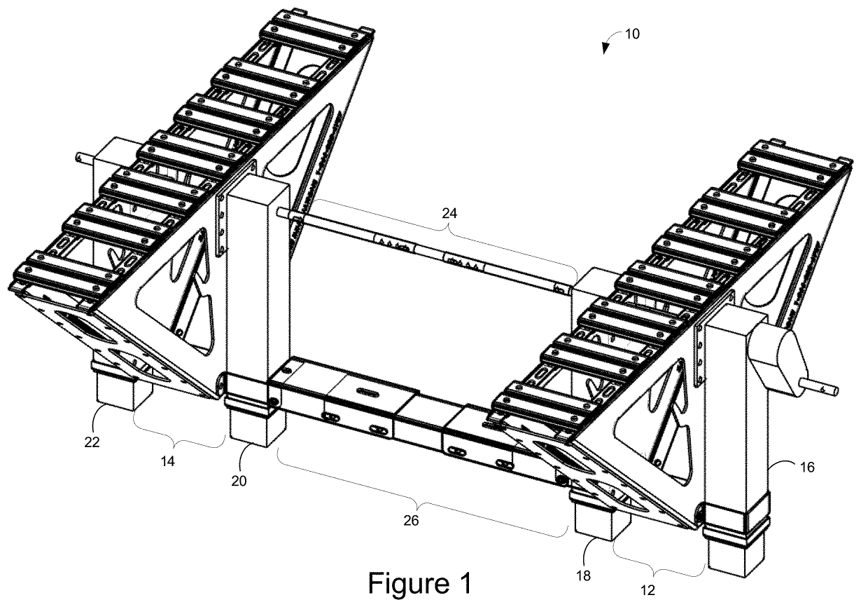

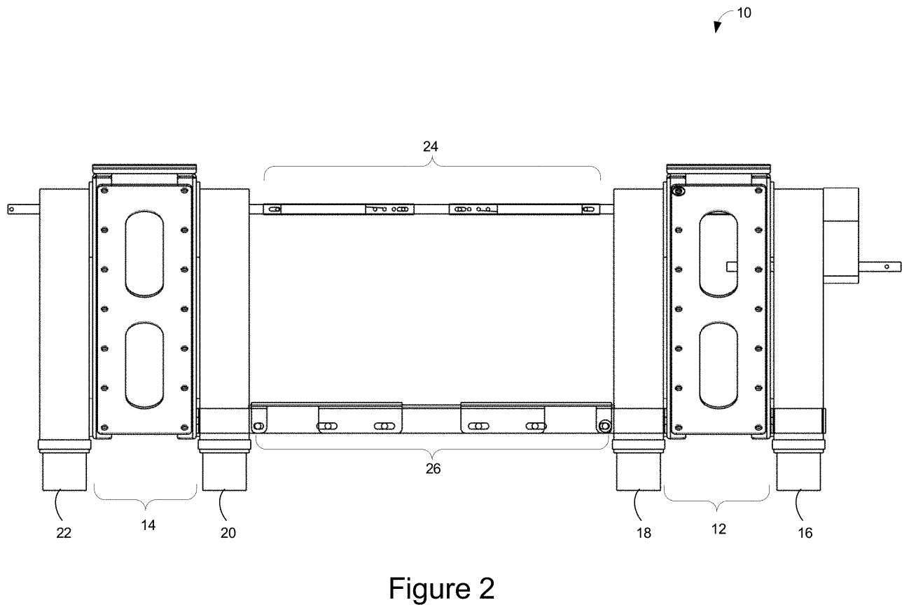

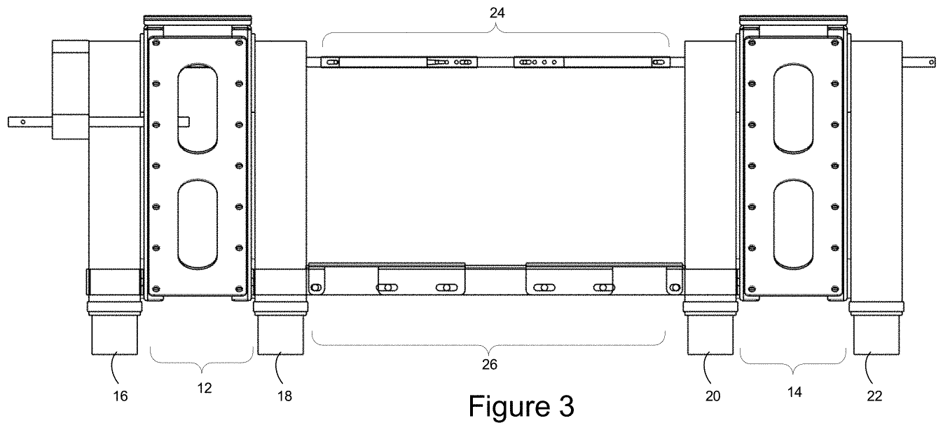

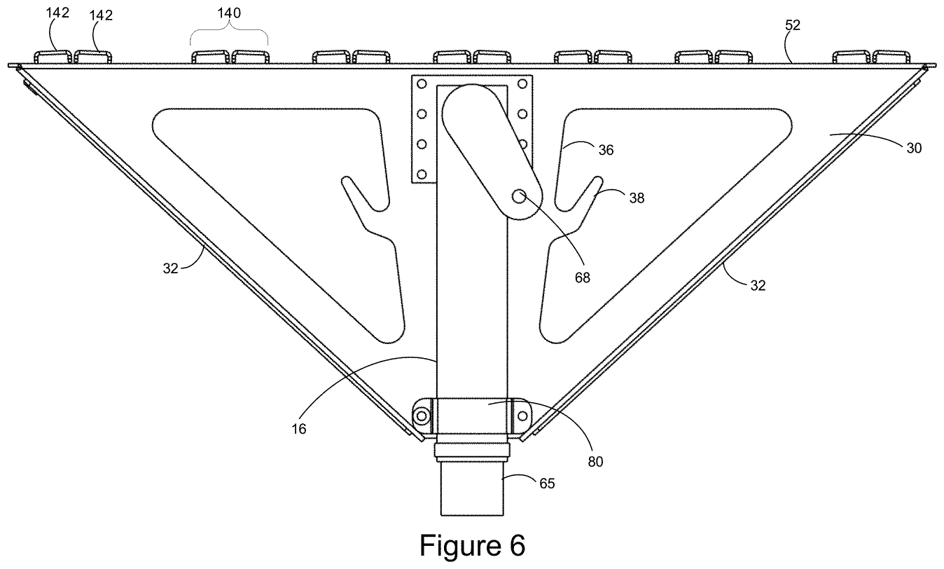

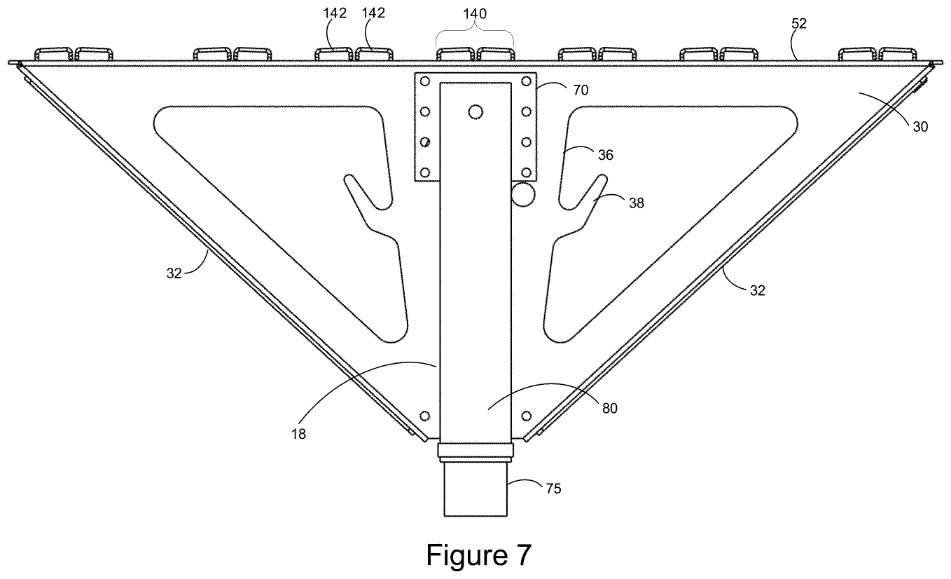

Turning now to FIGS. 1 to 7, an exemplary, landing gear 10 for a trailer is shown having at least two V-brace assemblies 12, 14. One V-brace assembly 12 is connected to a landing gear 16 on an outer side of the V-brace assembly 12 (shown in FIG. 6) and a single speed landing gear 18 on an inner side of the V-brace assembly 12. Landing gear 16 has a gear box. The second V-brace assembly 14 is connected to two single speed landing gears 20, 22 on an inner side and outer side, respectively, of the second V-brace assembly 14. The outer side of V-brace assembly 14 is shown in FIG. 7. The gears (not shown) of the single speed landing gear 18 on the inner side of V-brace assembly 12 and the gears (not shown) of the single speed landing gear 20 on the inner side of the second V-brace assembly 14, are operatively connected by an adjustable rotating assembly 24. An adjustable center support assembly 26 connects the single speed landing gear 18 and the single speed landing gear 20.

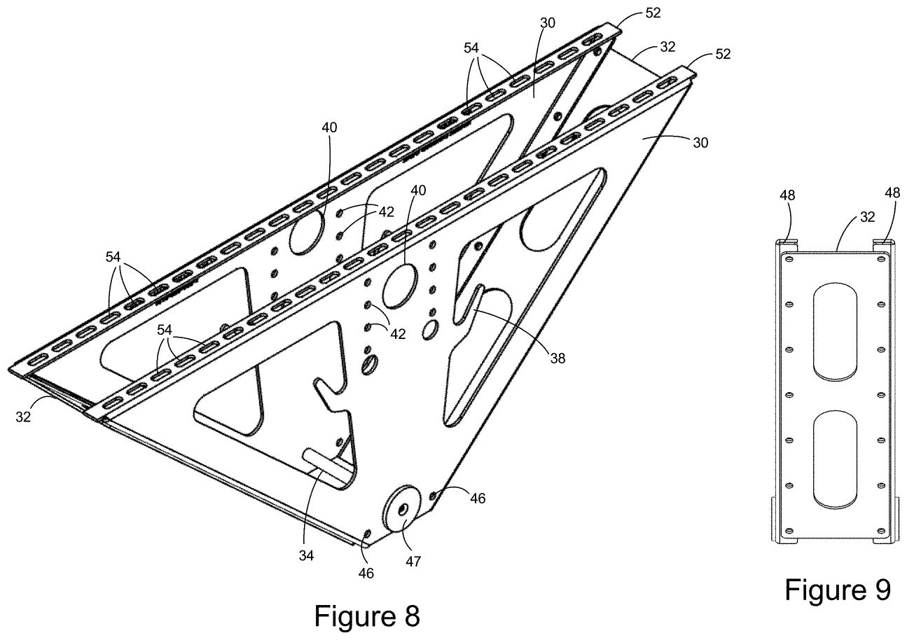

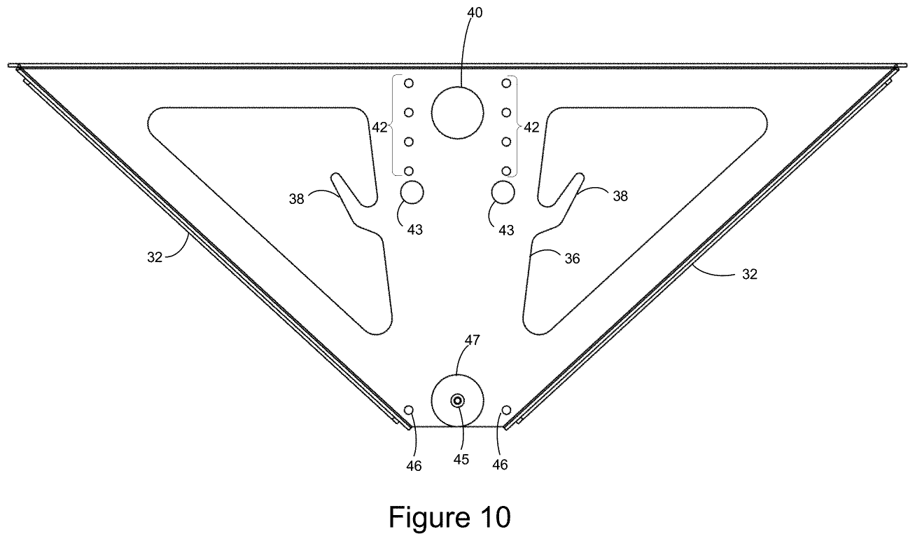

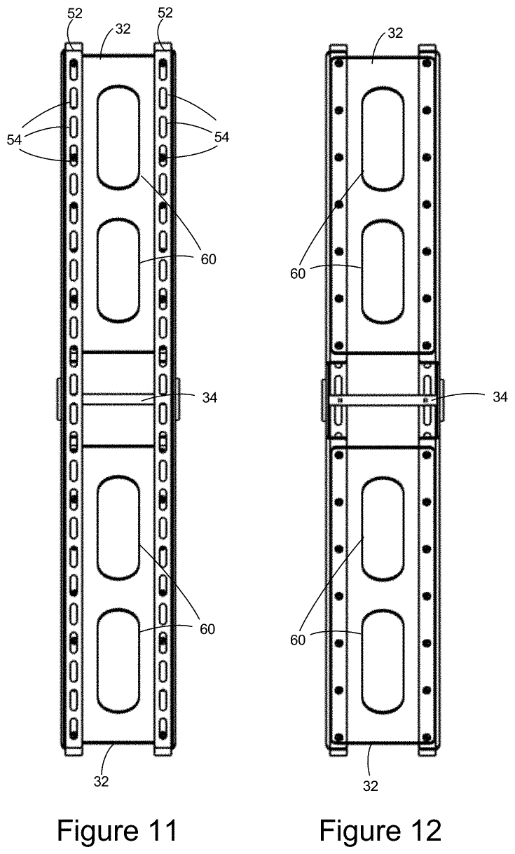

Various views of a single V-brace assembly 12, 14 are shown in FIGS. 8 to 12. V-brace assembly 12, 14 have at least two substantially V-shaped gussets 30 connected by a tie plate 32 on both sloped edges and by a support rod 34 which transverses the width of the space between the gussets 30 created by the tie plates 32. The space between the gussets 30 may be determined by the amount of space that would ensure that each of the landing gears on each side of the gusset are sufficiently close to each other and yet spaced enough apart to ensure side-to-side rigidity, as well as ensuring that the clamping assemblies 140 will also be operational since their length is determined by this space.

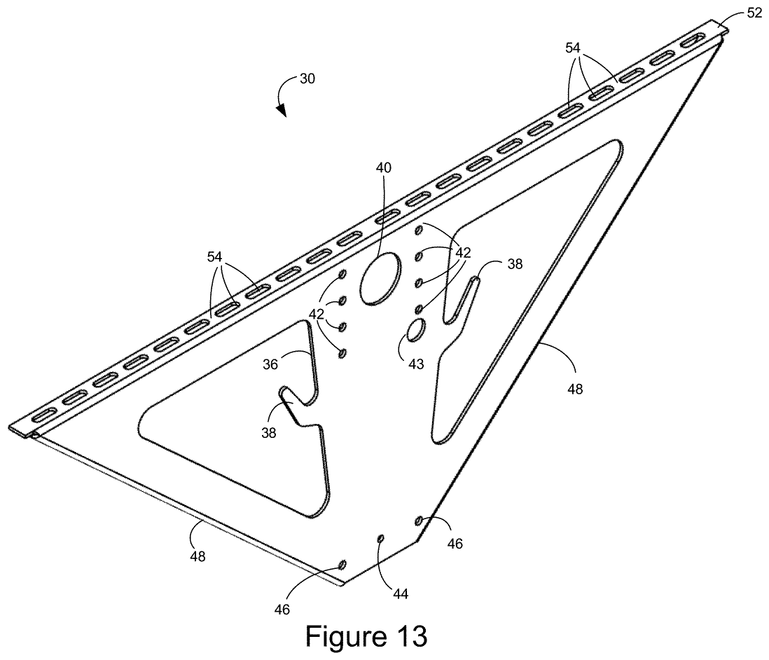

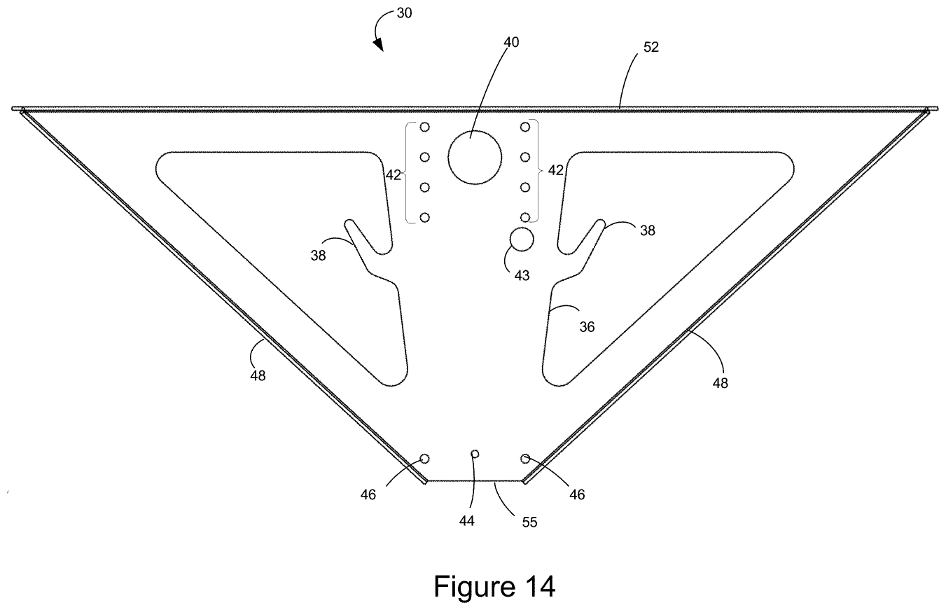

Various views of a single gusset 30 are shown in FIGS. 13 to 17. In this embodiment, the side view of gusset 30 shown in FIG. 14 is a substantially V-shaped plate, laser cut to have a central portion 36, such that there are cut-away portions on either side of the post. The cut away portions reduce the weight of the V-brace assembly 12, 14 and allow for ease of assembly of the V-brace assembly 12, 14. The central portion has hooks 38 on each side of the central portion 36 for holding the crank (not shown) of the landing gear 16 (with a gear box) during transport or in dock when the crank is not in use. Central portion 36 has a hole 40 substantially close to the top edge of the gusset 30 to accommodate therethrough the shaft from landing gear 16, 18, and its subsequent rotation. Central portion 36 may have a plurality of holes 42 to accommodate therethrough bolts for attaching a landing gear 16, 18, 20, or 22, secured by nuts (not shown). Central portion 36 may have at least one hole 43 beneath the plurality of holes 42, which may accommodate an extra-long input crank shaft of the landing gear 16 (with a gear box). At substantially the bottom of the central portion 36 are a plurality of holes. The middle hole 44 accommodates therethrough a bolt 45 for attaching the support rod 34, shown in FIG. 19, which traverses the space between gussets 30 in the V-brace assembly 12. A spacer disk 47 may be placed between the gusset 30 and the bolt head 45 or nut (not shown), acting as a washer for the bolts which attach to threaded boreholes 35 in support rod 34. The holes 46 on each side of the middle hole 44 accommodate therethrough bolts for attaching a strap 80 for supporting the landing gear, described in more detail below.

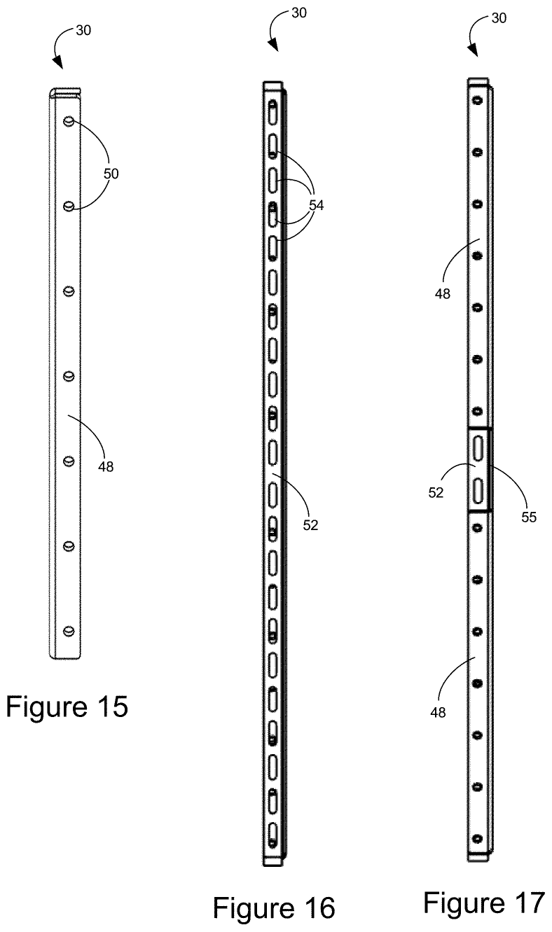

The front and rear sloped edges 48 of the gusset 30 are substantially identical and shown in FIG. 15. The sloped edges 48 are angled from the plate to form a surface that is substantially normal to the plate. The surface of the sloped edges 48 have a plurality of holes 50 to accommodate therethrough bolts for attaching the tie plates 32. FIG. 17 shows the bottom edge 55 of the gusset 30.

The top edge 52 of gusset 30, shown in FIG. 16, is angled to form a surface that is substantially horizontal to the plate in the same direction as the angled surfaces of the sloped edges 48. The surface of the top edge 52 has a plurality of slots 54 for slidably connecting a clamping assembly, which is described in more detail below.

The gusset 30 may be formed from a metal plate, such as a steel plate. The thickness of the steel plate may have a range of approximately an eighth of an inch to half an inch. As those skilled in the art will understand, any thickness of any metal plate may be used so that it accommodates and supports the weight of a trailer. The gusset 30 may be laser cut to form the various holes, slots, central portion, hooks, and cut-away portions. While a particular shape of hooks and cut-away portions are shown, it is understood that any shape of hooks and cut-away portions are possible. The height of the gusset 30 may be determined by the height of the landing gear and the amount of clearance that may be required between the landing gear assembly and the ground. The width of the gusset may be determined by how much of the surface of the bottom of the trailer is to be engaged.

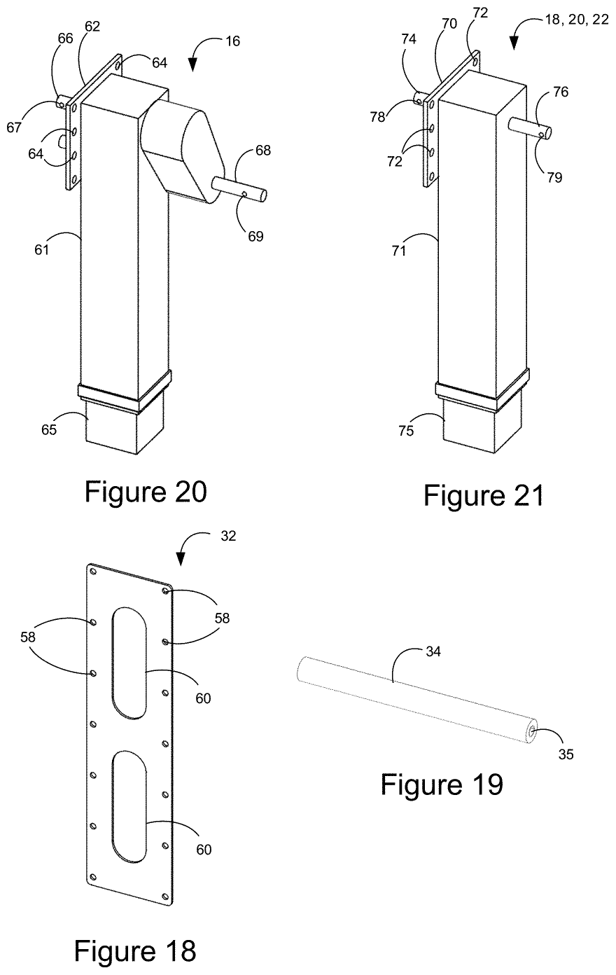

The tie plate 32 is shown in more detail in FIG. 18. The tie plate 32 is substantially oblong. Along the length of each side of the tie plate 32 are a plurality of holes 58 to accommodate bolts therethrough to connect the tie plate 32 on each edge to a gusset 30. The tie plate 32 may have at least one central slot 60 to reduce overall weight of the V-brace assembly 12, 14, and to allow for ease of construction of the V-brace assembly 12, 14. The width of the tie plate 32 is determined by the width of the space between the gussets 30 of the V-brace assembly 12, 14.

The tie plate 32 may be formed from a metal plate, such as a steel plate. The thickness of steel plate may be a range of approximately an eighth of an inch to a half inch. As those skilled in the art will understand, any thickness of a plate of any type of metal may be used so that it accommodates and supports the weight of a trailer. The tie plate may be laser cut to form the various holes and slots. While a particular shape slots and holes are shown in the Figures, it is understood that any shape of slots and holes are possible.

FIG. 19 shows the support rod 34 in more detail. Support rod 34 is substantially cylindrical with two ends, which may have threaded boreholes 35 in each end. As described above, the threaded boreholes 35 accommodate bolts which traverse holes 44 in the gusset 30.

FIG. 20 shows a typical landing gear 16 with a gear box. Landing gear 16 has a housing 61 in which a landing post 65 is telescopically arranged. Landing post 65 is raised and lowered from the housing 61 via gears (not shown) within the housing 61, which are operated by a crank shaft 68. Landing gear 16 is also connected to a connecting plate 62 with a plurality of holes 64 that substantially line up with the plurality of holes 42 on the central portion 36 of the gusset 30 and accommodate bolts for connecting the landing gear 16 to the gusset 30 of the outer side of V-brace assembly 12. Landing gear 16 has a crank shaft 68 that may connect to a crank (not shown) for operating the gear box within landing gear 16. When the crank shaft 68 is operated, the gear box causes the landing post 65, telescopically arranged in landing gear 16, to raise or lower depending on the direction of rotation. As the crank shaft 68 operates, a shaft 66 is also rotated to operate any other landing gears connected to the shaft 66. Any commercially available landing gear with a gear box may be used.

FIG. 21 shows a typical single speed landing gear 18, 20, 22. Single speed landing gear 18, 20, 22 has a housing 71 in which a landing post 75 is telescopically arranged. Landing post 75 is raised and lowered from the housing 71 via gears (not shown) within the housing 71, which are operated by the shafts 74 and 76. Single speed landing gear 18, 20, 22 has a connecting plate 70 with a plurality of holes 72 that substantially line up with the plurality of holes 42 on the central portion 36 of the gusset 30. The plurality of holes 72 and 42 accommodate bolts therethrough for connecting the single speed landing gear 18 to the other side of the first V-brace assembly 12, (i.e., the opposite side to that which is connected to the landing gear 16) or for connecting single speed landing gear 20, 22 on either side of second V-brace assembly 14. Single speed landing gear 18, 20, 22 has a first rotating shaft 74 and a second rotating shaft 76 which operate in tandem such that when first rotating shaft 74 is rotated, second rotating shaft 76 also rotates and vice versa. The shafts of each landing gear may connect in series to a rotating assembly 24 (which will be described in further detail below), such that when the crank shaft 68 of landing gear 16 is operated, the shafts of the other landing gears, 18, 20, and 22 are operated via the adjustable rotating assembly 24 to operate all landing gears in tandem. The rotating assembly will be described in further detail below. Any commercially available landing gear with a gear box may be used.

As the landing gear assembly 10 is assembled, the two outside landing gears 16 and 22 are adjusted so that the landing posts 75 and 95 will touch the ground when the landing gear assembly is attached to the bottom of a trailer. The two inner landing gears 18 and 20 are adjusted so that each of their posts 75 will not touch the ground when the landing gear assembly 10 is attached to the bottom of a trailer. The posts 75 of landing gears 18 and 20 are adjusted to be a range of approximately 1 inches to approximately 2 inches off the ground, with typical adjusted height of approximately 1 and a half inches off the ground. Thus, the posts 75 of landing gears 18 and 20 will be higher than the landing posts 75 and 95 of landing gears 16 and 22 by approximately 1 to 2 inches. In the event that landing gear 16 and/or 22 fails, landing gear 18 and/or 20, respectively, will engage the ground as the trailer begins to tip thus preventing the trailer from falling any further. The inner landing gears 18 and 20 may eliminate the need for further landing gear fail-safes such as trailer stands. Alternatively, during installation, inner landing gears 18 and 20 may be adjusted to touch the ground and outer landing gears 16 and 22 may be adjusted to be 1 to 2 inches off the ground. In this case, in the event that landing gear 18 and/or 20 fails, landing gear 16 and/or 22, respectively, will engage the ground as the trailer begins to tip thus preventing the trailer from falling any further.

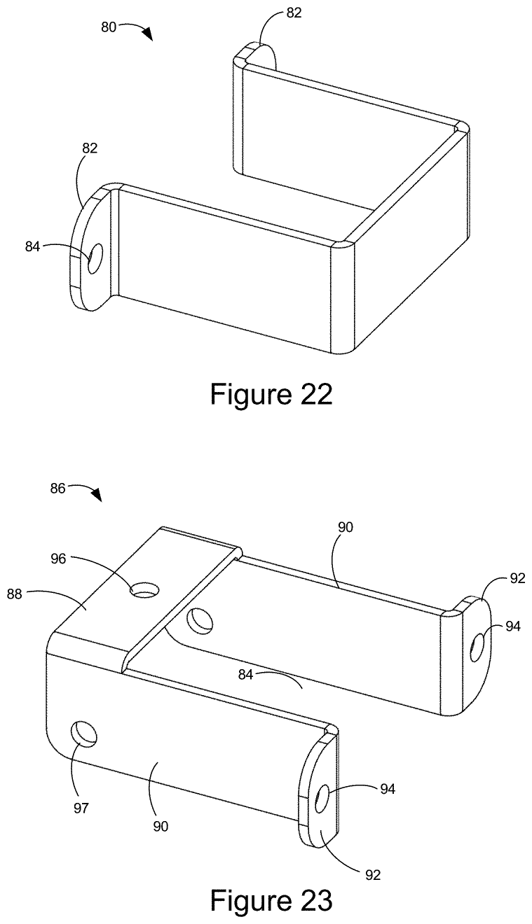

FIG. 22 shows a strap 80 for connecting the lower portion of landing gears 16 and 22 on the outside of the landing gear assembly 10 on the outside of each of V-brace assembly 12 and 14, respectively. The strap 80 is angled to form a substantially U-shaped strap and attachment surfaces 82. Attachment surfaces 82 have holes 84 that substantially line up with holes 46 of the gusset 30. When assembled, strap 80 is placed around the lower portion of the landing gear 16, 22 and holes 46 and 84 accommodate bolts therethrough to attach the landing gear 16, 22 to the outside of each of V-brace assembly 12 and 14, respectively. Strap 80 may be made of plate metal.

FIG. 23 shows a strap 86 with a supporting plate 88 for connecting the lower portions of the landing gears 18 and 20 to the insides of each of V-brace assembly 12 and 14 respectively. The strap 86 is angled to form a substantially U-shaped strap having a cross supporting plate 88 connected to two sides 90 with attachment surfaces 92. Attachment surfaces 92 have holes 94 that substantially line up with holes 46 of the gusset 30. When assembled, strap 86 is placed around the lower portion of the landing gear 18 and 20 and holes 46 and 84 accommodate bolts therethrough to attach the landing gear 18 and 20 to the inner side of each of V-brace assembly 12 and 14, respectively. The cross supporting plate 88 forms a surface to which the adjustable center support assembly 26 attaches via a bolt (not shown) through hole 96, which is described in further detail below. Strap 86 may be made of plate metal.

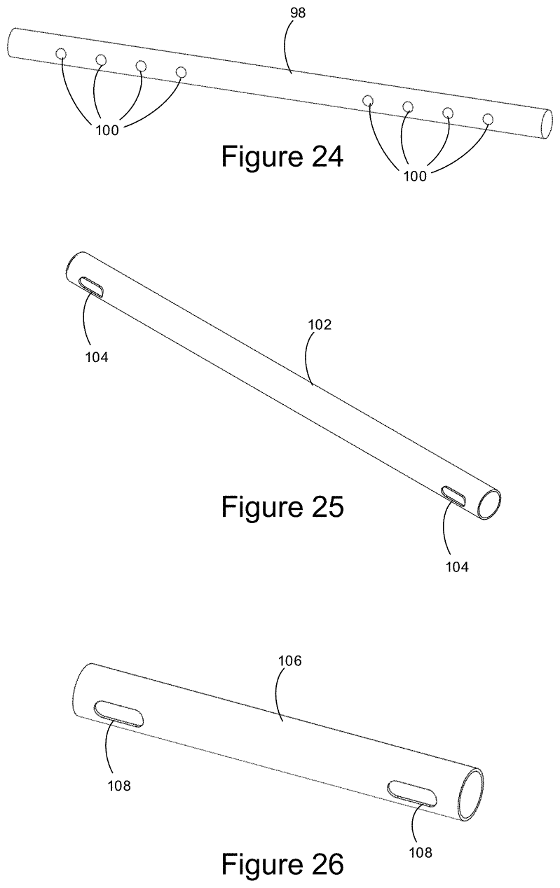

The components of the adjustable rotating assembly 24 are shown in FIGS. 24 to 26. The adjustable rotating assembly 24 spans the distance between the V-brace assemblies 12, 14, connecting the landing gear shafts, such that when the crank shaft of landing gear 16 is rotated, all gear shafts of all the other landing gears 18, 20, 22 are rotated simultaneously thereby raising and lowering the landing gears together. FIG. 24 shows a center rotating rod 98. Center rotating rod 98 is substantially cylindrical, having two ends with a plurality of holes 100 traversing the diameter of the center rotating rod 98 at each end. Center rotating rod 98 may be hollow or solid. Center rotating rod 98 may be made of a metal.

Each end of the center rotating rod 98 is slideably connected to an adjustable rotating tube 102, shown in FIG. 25. Adjustable rotating tube 102 is substantially cylindrical and hollow, and has two ends. Adjustable rotating tube 102 may be made of metal such as steel.

Each end of adjustable rotating tube 102 has a slot 104, which traverses therethrough the diameter of the adjustable rotating tube 102. One end of center rotating rod 98 fits within one end of the adjustable rotating tube 102. During assembly of the landing gear assembly, as the center rotating rod 98 is fit into the adjustable rotating tube 102, the slots 104 at each end of the adjustable rotating tube 102 will align with one of the plurality of holes 100 in the center rotating rod 98 when the desired width between the V-brace assemblies 12 and 14 is reached. Slots 104 are longer than holes 100 allowing for inconsistencies in spacing of the holes or in varying desired widths. When the desired width is reached, a bolt is placed through the slot 104 and the aligned hole of the plurality of holes 100, thereby securing the width of the adjustable rotating assembly 24 during installation. The desired width is determined by the width of the trailer to which the landing gear assembly 10 is being attached. In some embodiments, guides on the bottom of the trailer will determine where each outside landing gear 16, 22 are placed, which thereby determines the space between the V-brace assemblies 12, 14.

The other ends of adjustable rotating tube 102 (i.e., those ends that are not connected to the center rotating rod 98), are slideably connected to the shafts 76 of each of the single speed landing gears 20 and 22. The slots 104 in this end of the adjustable rotating tube 102 may align with a hole 78 in each shaft 76 and may be connected via a bolt placed therethrough.

FIG. 26 shows a rotating connecting tube 106 which is substantially cylindrical and hollow, and has two ends. Rotating connecting tube 106 may be made of metal such as steel. Each end of rotating connecting tube 106 has a slot 108. Rotating connecting tube 106 is positioned within the V-brace assemblies 12, 14 and transverses the space between the gussets 30.

Within V-brace assembly 12, the rotating connecting tube 106 fits over shaft 66 of landing gear 16 at its first end and fits over shaft 74 of landing gear 18, thereby connecting the shafts such that when crank shaft 68 is rotated, shaft 74 is also rotated. In this manner, when the landing post 65 of landing gear 16 is lowered, landing post 75 of landing gear 18 is also lowered the same amount at the same time. Slots 108 will align with holes 67 and 77 in shafts 66 and 74 respectively. Bolts may be placed through the slots 108 and holes 67 and 77 to secure the rotating connecting cylinder 108 to the shafts 66 and 74. Slots 108 are longer than holes 67 and 77 allowing for inconsistencies in spacing of the holes in the shafts.

Within V-brace assembly 14, the rotating connecting tube 106 fits over shaft 74 of landing gear 20 at its first end and fits over shaft 74 of landing gear 22, thereby connecting the shafts 74 of each landing gear 20, 22. Since the other shaft 76 of landing gear 20 is connected to the adjustable rotating assembly 24, and the other shaft 76 of landing gear 18 is connected to the other end of adjustable rotating assembly 24, all landing gears 16, 18, 20, 22 will operate in tandem when the when crank shaft 68 is rotated. In this manner, when the landing post 65 of landing gear 16 is lowered, landing posts 75 of landing gear 18, 20, and 22 are also lowered the same amount at the same time. Slots 108 will align with holes 67 and 77 in shafts 66 and 74 respectively. Bolts may be placed through the slots 108 and holes 67 and 77 to secure the rotating connecting tube 106 to the shafts 66 and 74. Slots 108 are longer than holes 67 and 77 allowing for inconsistencies in spacing of the holes in the shafts.

While the shapes of center rotating rod 98, adjustable rotating tube 102, and rotating connecting tube 106 are shown to be substantially cylindrical, those skilled in the art will understand that other shapes are possible and will depend on accommodating the shapes of the shafts of the landing gears.

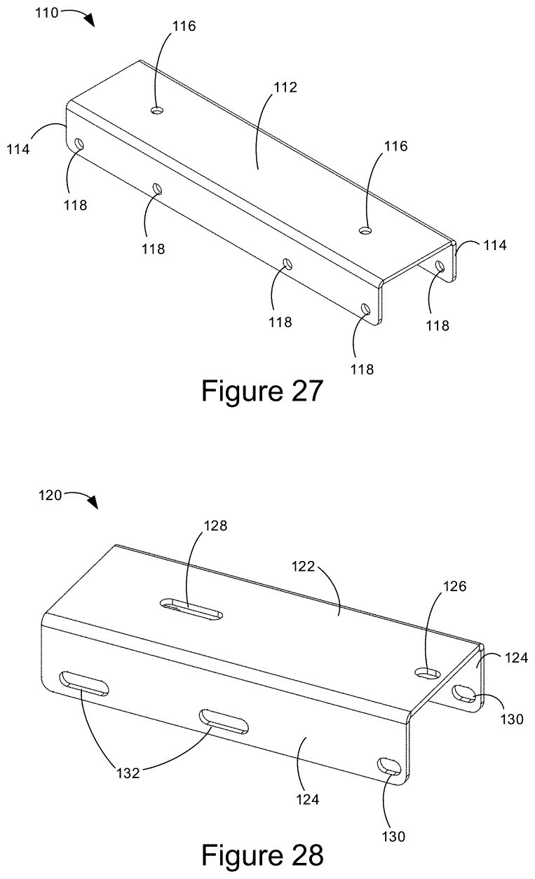

FIGS. 27 and 28 show the components of the adjustable center support assembly 26 of the landing gear assembly 10 of FIG. 1. The adjustable center support assembly 26 is positioned between the center landing gears 20, 22 at the lower portions of the landing gears. The adjustable center support assembly 26 comprises a center support brace 110 slideably connected on to two cross support braces 120 at each end of the center support brace 110.

FIG. 27 shows a center support brace 110, which is substantially oblong and has a top 112 and two sides 114. Center support brace 110 is formed from metal plate, such as steel plate. The steel plate may be angled to form the top 112 and the two sides 114 which are substantially orthogonal to the top, such that from a side profile, each end of center support brace 110 is substantially U-shaped. The top 112 of center support brace 110 has at least two holes 116 at each end. Sides 114 have a plurality of holes 118 along its length.

FIG. 28 shows a cross support brace 120, which is substantially oblong and has a top 122 and two sides 124. Cross support brace 120 is formed from metal plate, such as steel plate. The steel plate may be angled to form the top 122 and the two sides 124 which are substantially orthogonal to the top, such that from a side profile, each end of cross support brace 120 is substantially U-shaped. The width of cross support 120 is such that cross support brace 120 may fit over central support brace 110.

The top 122 of cross support brace 120 has a short slot 126 at a first end and a long slot 128 at a second end. Each of the sides 124 have a short slot 130 at the first end and at least one long slot 132 at the second end. The first end of the cross support brace 120 is sized and shaped to fit over the supporting plate 88 of strap 86. Short slot 126 aligns with hole 96 in the supporting plate, through which a bolt may be used to secure the cross support brace 120 to the supporting plate 88. Short slot 130 aligns with hole 97 in the sides 90 of strap 86, through which a bolt may be used to further secure the cross support brace 120 to the strap 86. Slots 126 and 130 are longer than holes 96 and 97 to allow for inconsistencies in spacing of the holes, or to help to achieve the desired width between the V-brace assemblies 12 and 14.

The second end of each cross support brace 120 fits slideably over one of the ends of the center support brace 110. Long slots 128 align with the holes 116 in the top 112 of center support brace 110, through which a bolt may be used to secure the cross support brace 120 to the center support brace 110. At least one long slot 132 aligns with at least one of the plurality holes 118. If there is more than one long slot 132, those slots may align with each of the plurality of holes 118. A bolt through aligned long slots 132 and holes 118 may be used to secure the cross support brace 120 to the center support brace 110. Slots 132 are longer than holes 118 to allow for and accommodate inconsistencies in spacing of the holes, or to help to achieve the desired width between the V-brace assemblies 12 and 14.

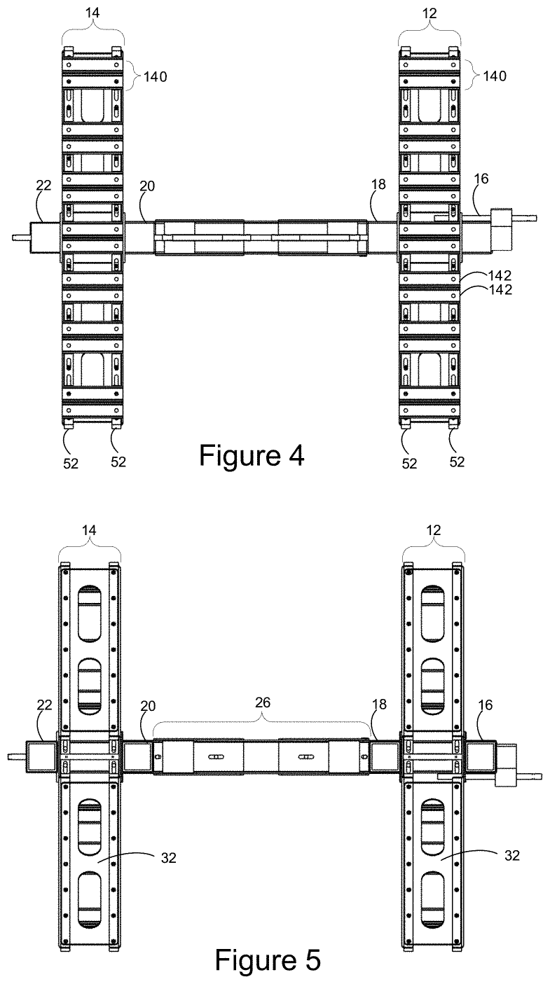

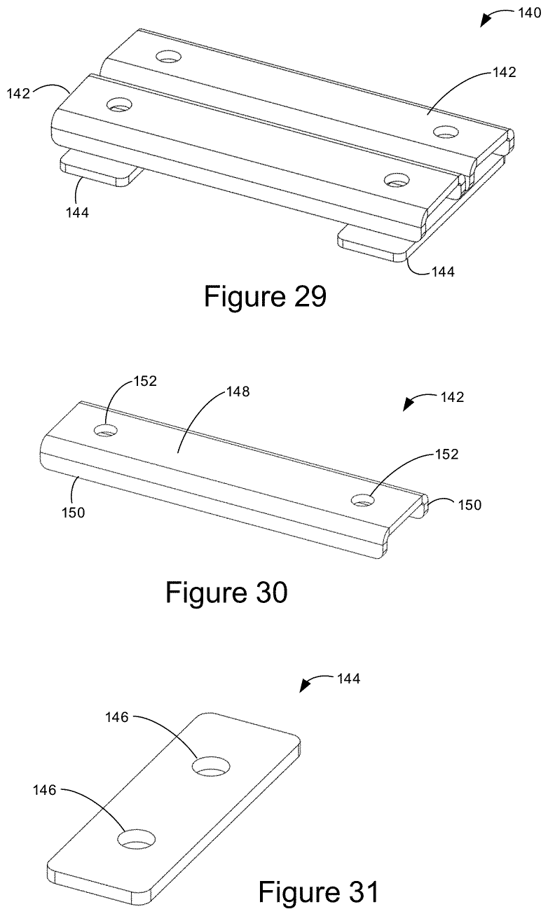

Turning back to FIGS. 1 and 4, the landing gear assembly 10 further comprises a plurality of clamping assemblies 140 on the top edge of each of the V-brace assemblies 12, 14. A single clamping assembly 140 can be seen in more detail in FIG. 29. Clamping assembly 140 comprises two top clamps 142 and two clamp supports 144. Each clamp support 144 is engaged by a pair of top clamps 142 at the ends of each of the top clamps 142.

A single top clamp 142 is shown in FIG. 30. Top clamp 142 is made from metal plate that has been bent to form a top 148 and two sides 150, such that a side view at each end of the top clamp 142 is substantially C-shaped. The top 148 has a hole 152 at each end of the top clamp 142. While the Figures show the top clamps to be substantially C-shaped, it is understood that any shape clamp may be used.

A single clamp support 144 is shown in FIG. 31. In this embodiment, clamp support 144 is substantially oblong plate having two holes therethrough 146. Each clamp support 144 abuts lengthwise the bottom of one of the surfaces of the top edges 52 of one of the gussets 30. The holes 146 align with the slots 54 in the surface of the top edge 52.

Turning back to FIG. 29, a single clamp assembly 140 is described as an example. A first end of a top clamp 142 sits on the top surface of a first top edge 52 of a first gusset 30 of one of the V-brace assembly 12, 14. The top clamp 142 traverses the width of the V-brace assembly 12, 14 so that a second end of the top clamp 142 sits on the second top surface of the second top edge 52 of the second gusset 30 of same the V-brace assemblies 12, 14, as shown in FIG. 1 and FIG. 4. The holes 152 of the top clamp 142 align with slots 54 in the top surface of the top edge 52, which in turn, are aligned with holes 146 in the clamp support abutting the bottom surface of the top edge 52 on each of the gussets 30. Bolts and nuts may be used through the holes 152, slots 54, and holes 146 and secured with a nut against the clamp support 144. The slots 54 are longer than either of the holes 146 or 152, allowing the clamping assembly 140 to be moved along the surface of the top edge 52 to accommodate for the size and spacing of connecting elements of the trailer, as described in further detail below.

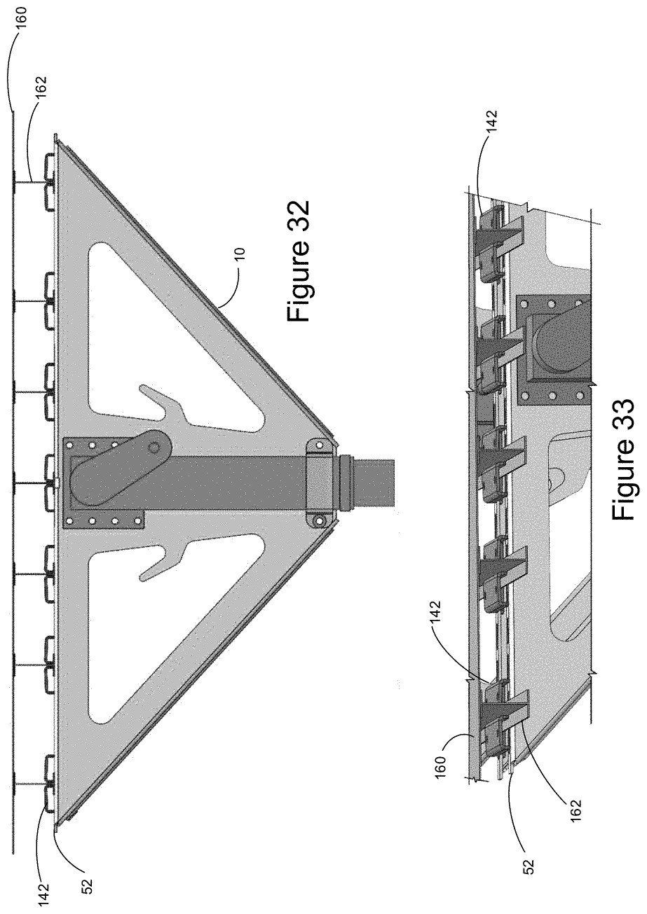

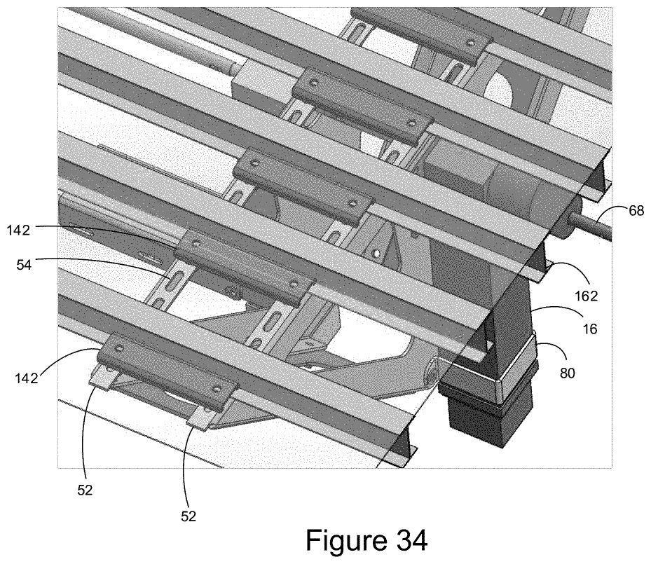

FIG. 32 shows the assembled landing gear assembly 10 attached to the bottom of a trailer 160 (shown as cutaway in FIG. 33). The bottom of a typical trailer 160 is formed by a series of I-beams 162 traversing the width of the trailer with a floor surface attached to the tops of the series of I-beams 162. To attach the landing gear assembly 10 to the bottom of the trailer 160, the bottoms of a plurality of I-beams 162 are held to the top edge 52 of each gusset 30 of each V-brace assembly 12, 14. One side 150 of each of the top clamps 142 raises to engage a top side of a bottom flange of an I-beam 162. The bottom side of the bottom flange of the !-beam 162 abuts the top surface of the top edge 52. The other side 150 of the top clamp 142 remains engaged with the clamp support 144. The top clamp is secured over the top side of the bottom flange by a bolt and nut (not shown) through the hole 152, through aligned slot 54, and through aligned hole 146, thereby retaining the I-beam 162 to the landing gear assembly 10. Slots 54 of the top edge 52 of the gusset 30 are sized to allow for inconsistencies in the spacing of the I-beams 162 so that the top clamp 142 and clamp support 144 can move within the slot 54 until it properly engages the bottom flange of the I-beam 162. FIG. 33 shows a close-up, cut-away view of the top clamps 142 engaging the bottom flanges of the I-beams 162. Each I-beam is engaged on both bottom flanges by a top clamp 142. FIG. 34 shows a top, cut-away view of the top clamps 142 engaging the bottom flanges of the I-beams 162. In this view, the bolts, nuts, and clamp supports are not visible.

While FIGS. 29, 30, and 31 to 34 show the top clamps 142 to be substantially C-shaped, it is understood that any shape top clamp may be used to secure the bottom flange of the I-beam. In one non-limiting example, the top clamp may be a wedge, which sits over the flange at its thinner end and is secured at its thicker end to the top edge 52. In another non-limiting example, the top clamp may be a plate that sandwiches the bottom flange between itself and the top edge 52.

While FIGS. 29, and 32 to 34 show the clamp support 144 as a pair which each engage the underside of top edge 52, it is understood that clamp support may be a single support the same length as the top clamp 142, which also traverses the width of the V-brace assembly 12, 14. As a skilled person will also understand, the clamp support 144 may also support a single clamp rather than a pair of clamps. A skilled worker will also understand that the clamping assemblies 140 may be used with any type of landing gear assembly configuration. In a non-limiting example, the clamping assemblies 140 may be used with a landing gear assembly that only has one landing gear rather than a pair of landing gears.

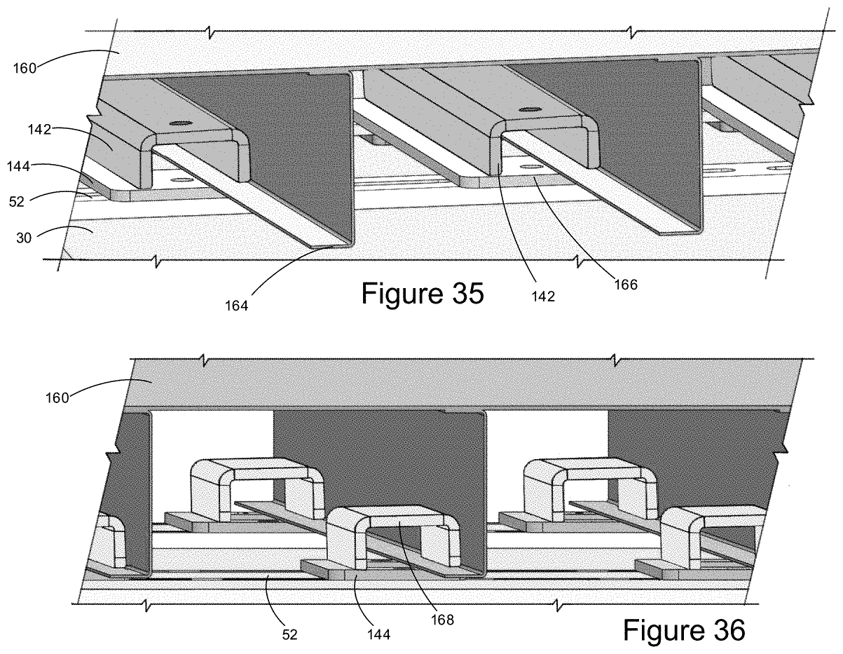

FIG. 35 shows an alternative embodiment of the top clamps 142 in the case where a trailer 160 utilizes angled steel beams 164 rather than I-beams. In this embodiment, only one top clamp 142 engages the bottom of the angled beam 164. In this example, the top clamp 142 sits on an extra clamp support 166, which sits on the top surface of the top edge and traverses the width of the V-brace assembly 12, 14.

FIG. 36 shows yet another embodiment of the top clamps. In this example, the trailer again utilizes angled beams 164. In this embodiment, top clamps 168 are short and do not traverse the width of the V-brace. Rather than each bottom of the angled beam being engaged by only one top clamp as in FIG. 35, each bottom of the angled beam is engaged by two short top clamps 168 sitting on supports 144 on each of the top edges 52 of each gusset 30.

The landing gear assembly 10 depicted in FIGS. 1 to 36 may be constructed using bolts and nuts for connecting the various parts of the assembly rather than welds. While bolts are not always shown in the Figures, for ease of illustration, every part may be connected using bolts and nuts through through-holes in each part. One skilled in the art will readily understand that bolts and nuts may be substituted for other securing means, such as welding.

Once the landing gear assembly 10 is constructed and attached to a trailer, there is no need for an operator to make any adjustments since once deployed, the landing gear assembly 10 engages the ground and has a failsafe of the inner landing gears 18, 20. Alternatively, if the outer landing gears 16 and 22 are installed so that they are higher than the inner landing gears 18, 20, once deployed, the inner landing gears 18, 20 engage the ground and the landing gear assembly 10 has a failsafe of the outer landing gears 16 and 12. This may be a significant safety measure and may save a significant amount of time when parking and loading/unloading a trailer.

The landing gear assembly 10 may be assembled to any new trailer or retrofitted to any kind of existing freight trailer.

Each part of the landing gear assembly 10 may be made of metal. For example, metal plate such as steel plate. It is understood that any metal may be used for each part that is sufficient for supporting the weight of a trailer, its load, loading workers, forklifts, forklift operators, etc. It is understood that each part may be made of metal that may be of any thickness to sufficiently supporting the weight of a trailer, its load, loading workers, forklifts, forklift operators, etc.

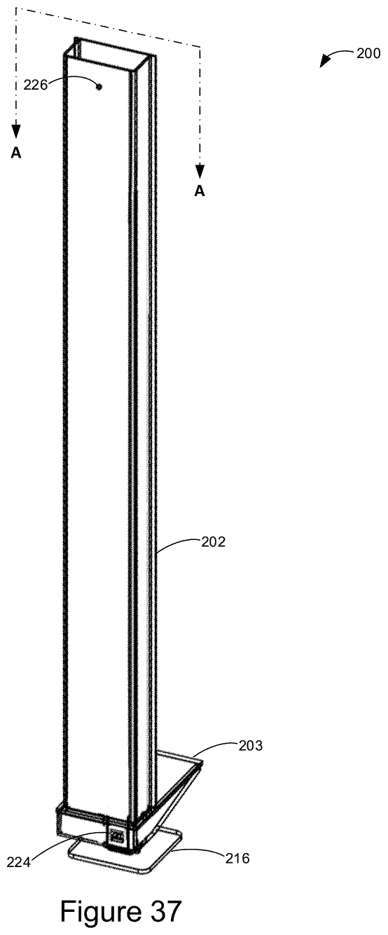

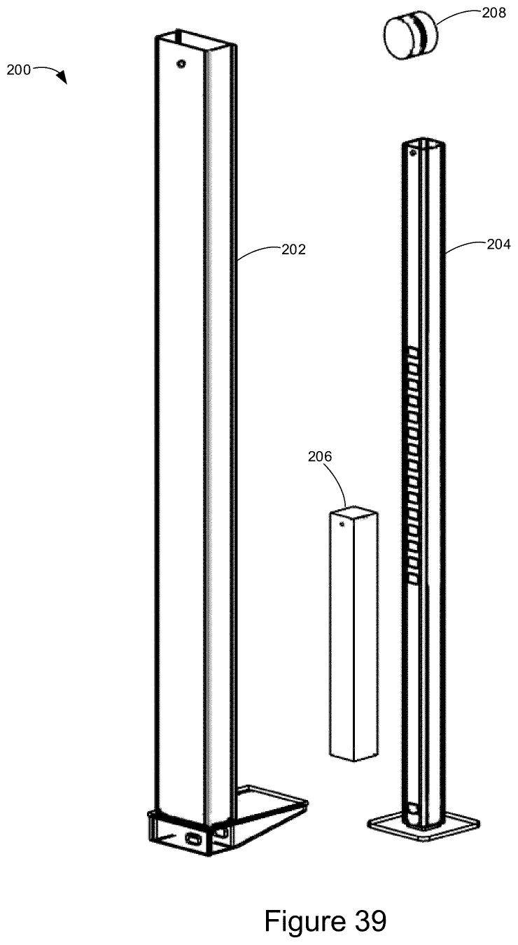

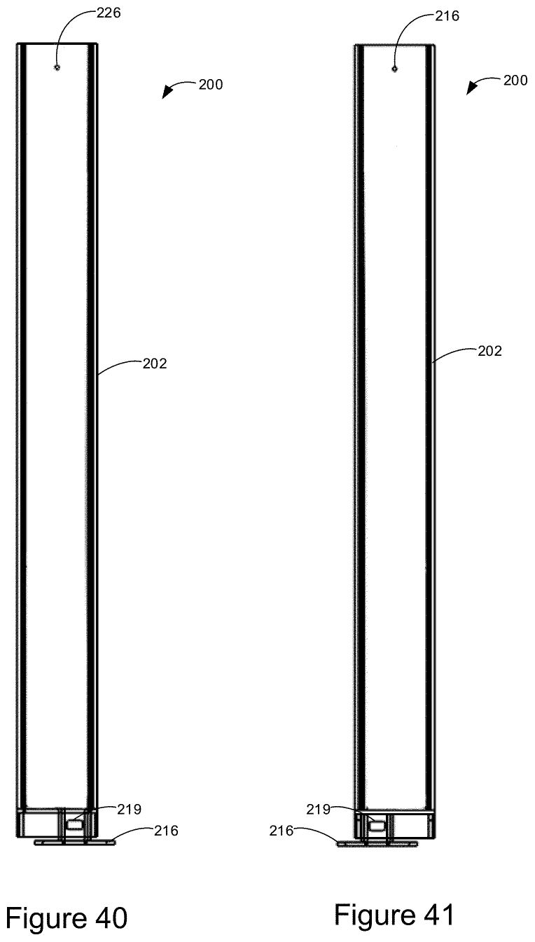

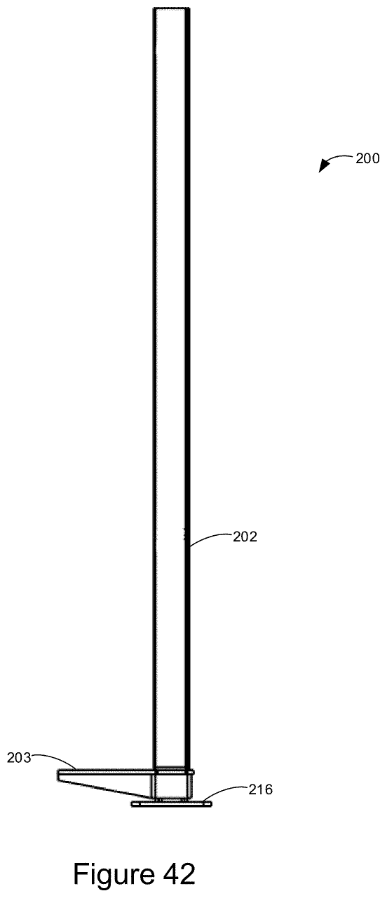

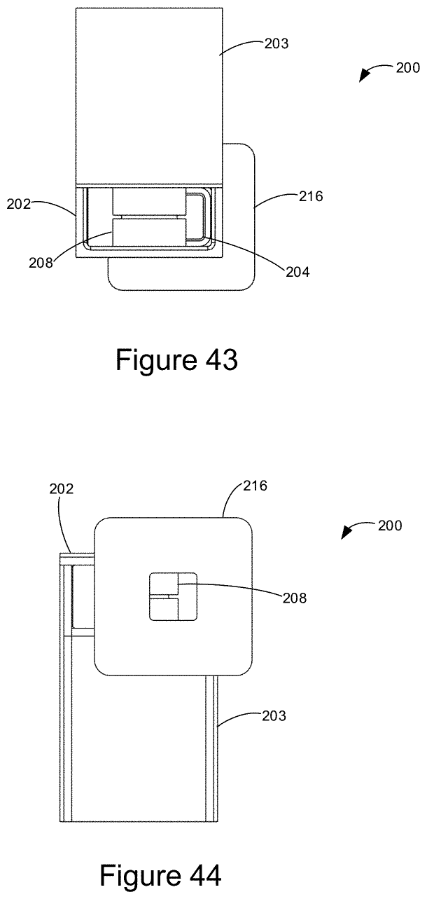

FIGS. 37 to 49 show an exemplary safety system for a trailer in the form of an auxiliary leg assembly and is generally referenced by the number 200. The leg assembly 200 comprises a housing 202, and operably positioned within the housing are an adjustable leg 204, a counterweight 206, and a pulley 208. The housing 202 may be a metal tube having open ends and a rear flange 203 extending from the rear face of the tube at the bottom of the tube.

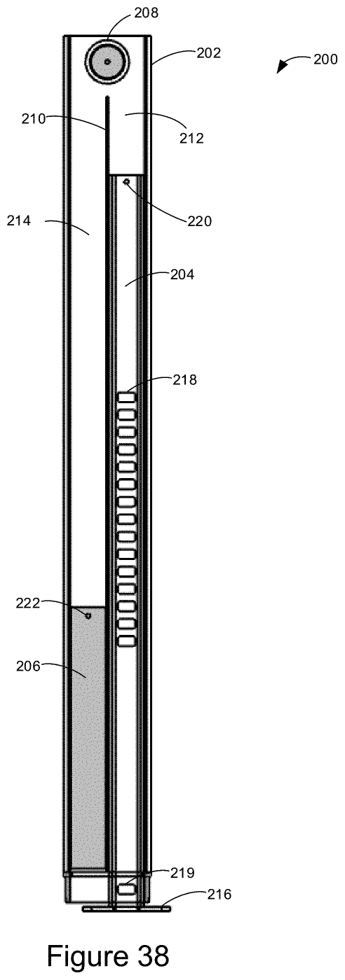

FIG. 38 shows a front view section drawing of the auxiliary leg assembly 200 along the cut-line A-A in FIG. 37. The housing 202 has a wall 210 that divides the housing into a first compartment 212 and a second compartment 214. There is space above the wall 210 to accommodate the pulley 208. The first compartment 212 houses the adjustable leg 204. The second compartment 214 houses the counterweight 206.

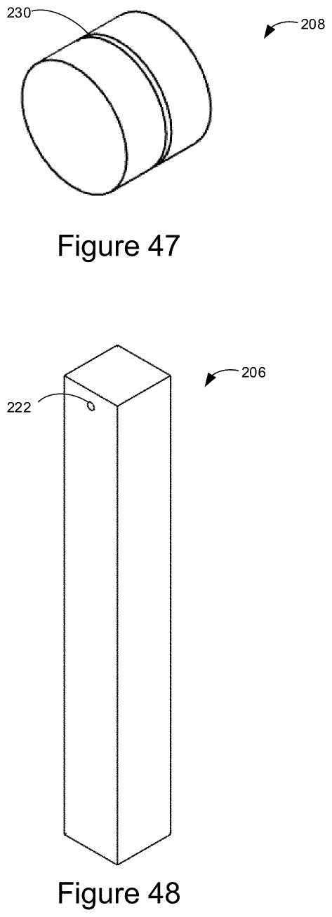

A pulling means (not shown for ease of illustration) has two ends, one of which connects to the adjustable leg though a hole 220 at the top of the adjustable leg 204. The pulling means sits within a groove 230 on the pulley 208, as seen in FIG. 47. The other end of the pulling means is connected to the counterweight 206 through a hole 222 in the top of the counterweight 206. The pulling means may be a cable or a chain or any other means by which the counterweight 206 and leg 204 can be raised or lowered via the pulley 208. The pulley 208 may be connected to the housing 202 through a hole 226 at the top of the housing for accommodating an axle (not shown) that traverses the pulley 208, allowing the pulley 208 to rotate around the axle. Alternatively, if the pulley 208 does not rotate and only facilitates the movement of the pulling means, then the pulley 208 may be welded in place at the top of the inside of the housing 202.

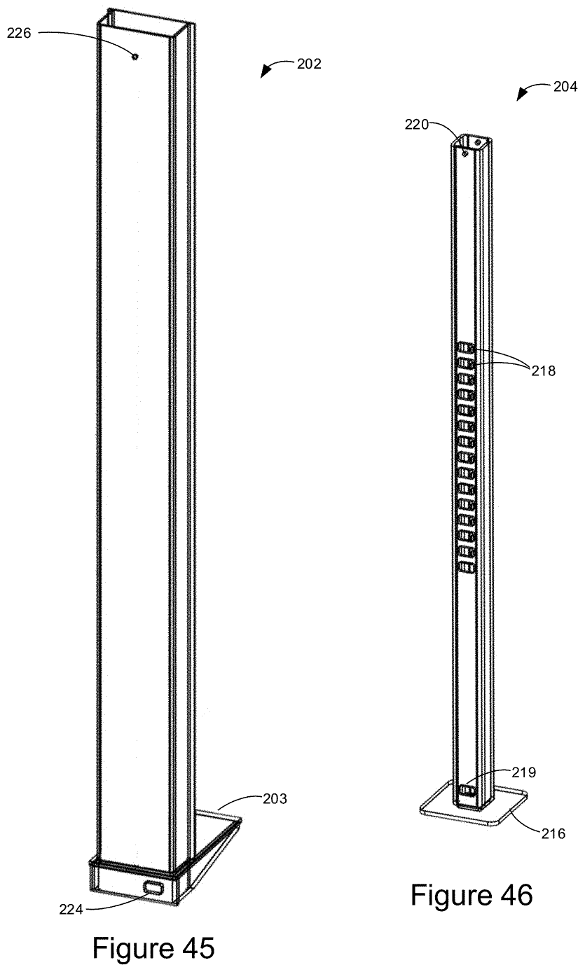

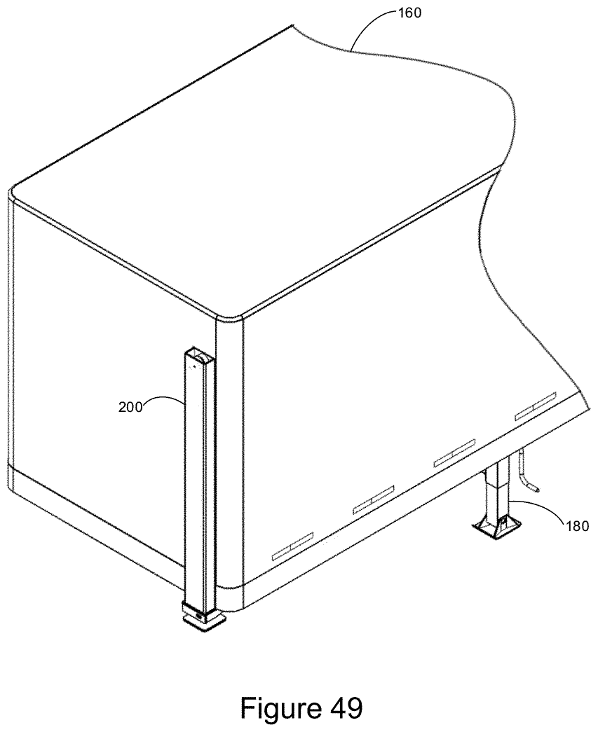

The housing 202 is shown in more detail in FIG. 45. The housing 202 has a rear flange 203 that is shaped to abut the underside of a trailer 160 (as shown in FIG. 49). The flange 203 may be welded to the underside of the trailer to secure the auxiliary leg assembly 200 to the trailer. However, as a skilled worker will readily appreciate, any securing means is possible. The rear face of the housing 202 may also be welded to the trailer. The bottom front face of the housing 202 has a slot 224 for accommodating a pin (not shown), which engages the adjustable leg 204.

The adjustable leg 204 is shown in more detail in FIG. 46. The adjustable leg 204 is a metal tube sized to fit within the first compartment 212 of the housing 202. The adjustable leg 204 has a base 216 at the bottom end of the tube that is larger than at least one of the width or breadth of the first compartment 212. When the tube portion of the adjustable leg 204 is fully contained within the housing, the base 216 remains outside the housing 202 at the bottom of the housing 202.

The front and rear face of the adjustable leg 204 have a plurality of slots 218, such that number and position of each slot is the same on both faces. The front and rear face of the adjustable leg 204 have an additional bottom slot 219 that aligns with the slot 224 in the housing 202 when the tube portion of the adjustable leg is fully contained within the first compartment 212. A pin (not shown) is placed therethrough the slot 224 in the housing 202 and the slots 219 in the adjustable leg 204 to secure the leg within the housing. The pin may be spring-loaded so that when released, the pin springs back into at least the slot 224. Other ways of securing the adjustable leg within the housing are possible. The pin may also be motorized or remotely controlled.

The counterweight 206 is shown in more detail in FIG. 48. The counterweight 206 is a substantially oblong bar with a hole 222 at the top of the counterweight 206 from the front face of the counterweight through to the back face of the counterweight 206. The counterweight 206 may be made from any material that provides enough weight to counter the movement of the leg 204 when it is released, yet allows the movement of the leg 204 when the leg is urged downwards. In another embodiment of the auxiliary leg assembly, the counterweight may be replaced with a motor, hydraulics, a spring, gas shock or other means of countering the movement of the leg 204 when it is released from the housing 202.

FIG. 49 shows an exemplary use of an auxiliary leg assembly 200 mounted on a typical freight trailer 160 having a typical landing gear 180. FIG. 49 shows the adjustable leg 204 is still contained within the housing 202.

In operation, the pin is released from the slots 219 and 224, manually or automatically by remote. The adjustable leg 204 is urged downwards gradually from the housing 202 as the counterweight 206 via the pulling means resists the leg 204 dropping down abruptly by gravity. The adjustable leg 204 may be urged downwards automatically or manually. When the base 216 of the adjustable leg 204 reaches the ground, the pin springs back into one of the plurality of slots 218 that now lines up with slot 224, securing the adjustable leg in place.

To retract the adjustable leg 204, the pin is released from slots 218 and 224, and the counterweight 206 descends due to gravity and gradually pulls the adjustable leg 204 back into the housing 202 via the pulling means and the pulley 208.

In FIG. 49, the auxiliary leg assembly 200 is mounted on the front of the trailer, however the auxiliary leg assembly 200 may be mounted anywhere on the trailer which will not interfere with movement, placement or width restrictions of the trailer. While FIG. 49 shows a single leg assembly 200, it is understood that a second or plurality of auxiliary leg assemblies may be used on a trailer to provide extra stability.

FIG. 49 shows the auxiliary leg assembly 200 mounted on the outside of the trailer 160, however, the leg assembly 200 may also be mounted on the inside of the trailer 160, such that the adjustable leg is able to lower through the floor of the trailer 160.

Unless otherwise explained, all technical terms used herein have the same meaning as commonly understood by one of ordinary skill in the art to which this disclosure belongs. Although any methods and materials similar or equivalent to those described herein can be used in the practice for testing of the present invention, the typical materials and methods are described herein. In describing and claiming the present invention, the following terminology will be used.

It is also to be understood that the terminology used herein is for the purpose of describing particular aspects only and is not intended to be limiting. Patent applications, patents, and publications are cited herein to assist in understanding the aspects described. All such references cited herein are incorporated herein by reference in their entirety and for all purposes to the same extent as if each individual publication or patent or patent application was specifically and individually indicated to be incorporated by reference in its entirety for all purposes. To the extent publications and patents or patent applications incorporated by reference contradict the disclosure contained in the specification, the specification is intended to supersede and/or take precedence over any such contradictory material.

In understanding the scope of the present application, the articles “a”, “an”, “the”, and “said” are intended to mean that there are one or more of the elements. Additionally, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

It will be understood that any aspects described as “comprising” certain components may also “consist of” or “consist essentially of,” wherein “consisting of” has a closed-ended or restrictive meaning and “consisting essentially of” means including the components specified but excluding other components except for materials present as impurities, unavoidable materials present as a result of processes used to provide the components, and components added for a purpose other than achieving the technical effect of the invention.

It will be understood that any component defined herein as being included may be explicitly excluded from the claimed invention by way of proviso or negative limitation.

In addition, all ranges given herein include the end of the ranges and also any intermediate range points, whether explicitly stated or not.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The abbreviation, “e.g.” is derived from the Latin exempli gratia, and is used herein to indicate a non-limiting example. Thus, the abbreviation “e.g.” is synonymous with the term “for example.” The word “or” is intended to include “and” unless the context clearly indicates otherwise.

What is claimed is:

1. A landing gear assembly for a trailer, the landing gear assembly comprising:
a first brace assembly having an outer surface, an inner surface, a top edge, a front sloped edge and a back sloped edge, the top edge having a first clamping assembly for engaging and retaining a bottom of the trailer;
a second brace assembly having an outer surface, an inner surface, a top edge, a front sloped edge and a back sloped edge, the top edge having a second clamping assembly for engaging and retaining the bottom of the trailer;
a first landing gear attached to the first brace outer surface;
a second landing gear attached to the first brace inner surface;
a third landing gear attached to the second brace outer surface;
a fourth landing gear attached to the second brace inner surface;
a center support assembly for connecting the first brace to the second brace; and
a rotating assembly for operating the first, second, third, and fourth landing gears in tandem.

2. A landing gear assembly for a trailer, the landing gear assembly comprising:
a first brace assembly having an outer surface, an inner surface, a top edge, a front sloped edge and a back sloped edge, the top edge having a plurality of first clamping assemblies for engaging and retaining a bottom of the trailer;
a second brace assembly having an outer surface, an inner surface, a top edge, a front sloped edge and a back sloped edge, the top edge having a second clamping assemblies for engaging and retaining the bottom of the trailer;
a first landing gear attached to the first brace outer surface;
a second landing gear attached to the second brace outer surface;
a center support assembly for connecting the first brace to the second brace; and
a rotating assembly for operating the first and second landing gears in tandem.

3. An auxiliary leg assembly for a trailer, the auxiliary leg assembly comprising:
a housing having a first compartment and a second compartment;
an adjustable leg housed within the first compartment and releasably secured in the housing;
a counterweight operably housed in the second compartment and connected to the adjustable leg for causing the gradually downward movement of the adjustable leg when the adjustable leg is released from the housing; and
a securing mechanism for securing the adjustable leg in the first compartment after it descends to a desired height.
